(19) United States
(12) Patent Application Publication
(10) Pub. No.: US 2009/0193195 A1
(43) Pub. Date: Jul. 30, 2009

(54) CACHE THAT STORES DATA ITEMS ASSOCIATED WITH STICKY INDICATORS

(76) Inventors: Robert A. Cochran, Sacramento, CA (US); Erik A. Lipps, Sacramento, CA (US); Charles A. Paridon, Cameron Park, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/210,790

(22) Filed: Sep. 15, 2008

Related U.S. Application Data
(60) Provisional application No. 61/023,533, filed on Jan. 25, 2008.

(51) Int. Cl. G06F 12/08; G06F 12/16; G06F 12/00

(52) U.S. Cl. 711/133; 711/162; 711/E12.001; 711/E12.022; 711/E12.103

(57) ABSTRACT

Data items are stored in a cache of the storage system, where the data items are for a snapshot volume. Sticky indicators are associated with the data items in the cache, where the sticky indicators delay removal of corresponding data items from the cache. Data items of the cache are sacrificed according to a replacement algorithm that takes into account the sticky indicators associated with the data items.

### BACKGROUND

Storage systems can be used to store relatively large amounts of data. Such storage systems can be provided in a network, such as a storage area network, to allow for remote access over the network by one or more hosts. An issue associated with storage systems is the possibility of failure, which may result in loss of data.

One recovery technique that has been implemented with some storage systems involves taking “snapshots” of data, with a snapshot being a copy of data taken at a particular time. A snapshot of data is also referred to as a point-in-time representation of data. If recovery of data is desired, data can be restored to a prior state by reconstructing the snapshot.

Multiple snapshots of data at different times can be stored in the storage system. Such snapshots refer to different generations of snapshots (with a “generation” referring to the particular time at which the snapshot was taken).

A snapshot subsystem of a storage system can be implemented with a snapshot primary volume and snapshot pool volumes, where the snapshot pool volumes are used to store old data. Typically, non-updated data is kept in the snapshot primary volume, while the snapshot pool volumes are used to store prior generations of data that have been modified at different times. Different snapshots can include different combinations of data from the snapshot primary volume and one or more volumes in the snapshot pool.

The storage system can receive requests from one or more hosts to actively utilize snapshots. For example, in a storage system that is capable of maintaining 64 snapshots, it may be possible that there may be up to 64 outstanding input/output requests to snapshots at a given time.

For improved throughput, caches are typically provided in storage systems. Caches are implemented with memory devices that have higher access speeds than persistent storage devices (e.g., magnetic disk drives) that are part of the storage system. If an access request can be satisfied from the cache (a cache hit), then an input/output (I/O) access of the slower persistent storage devices can be avoided. However, conventional cache management algorithms do not effectively handle scenarios where there may be multiple outstanding requests for snapshots, where the outstanding requests (which may be from multiple hosts) may each involve access of the snapshot primary volume. N (N>1) hosts requesting I/O against N snapshots will produce respective workload at N different Gaussian distributed random disk head locations (assuming that the persistent storage devices are disk drives). If each of the N requests against snapshots involves an access of the snapshot primary volume, then the disk head(s) associated with the snapshot primary volume will be distracted with the N snapshot read activity. Note that the primary volume may also be concurrently handling normal read requests (reads of the current data, rather than reads of snapshot data).

The increased workload and the fact that the snapshot primary volume is being accessed by multiple outstanding requests increases the likelihood of a cache miss, which can result in performance degradation, particularly during write operations to the snapshot subsystem. Note that each write to a snapshot subsystem can result in three times the I/O traffic, since a write to a snapshot subsystem involves the following: (1) read old data from the snapshot primary volume; (2) write old data to the snapshot pool of volumes; and (3) write new data to the snapshot primary volume. Conventional cache management algorithms that are not effectively designed to handle snapshots will lead to increased cache misses, which in turn will cause degradation of performance of the storage system.

### BRIEF DESCRIPTION OF THE DRAWINGS

Some embodiments of the invention are described with respect to the following figures:

FIG. 1 is a block diagram of an example arrangement that includes a storage system and an administrative station, in which an embodiment of the invention is incorporated.

FIG. 2 is a block diagram of logical elements (including a dirty queue, clean queue, and free queue) of a cache according to an embodiment.

FIG. 3 is a block diagram of a clean queue configured according to an embodiment.

FIG. 4 illustrates an example sequence of events with respect to the clean queue which cause data items to be moved in the queue.

FIG. 5 is a flow diagram of a process of caching data that involves use of sticky indicators according to some embodiments.

### DETAILED DESCRIPTION

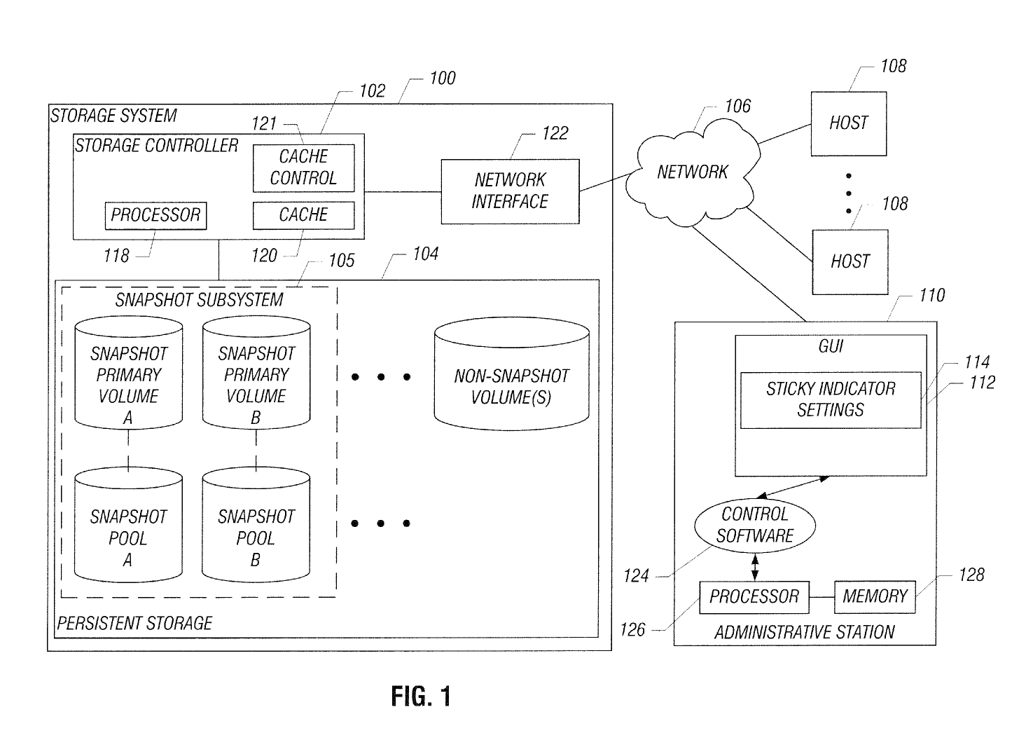

FIG. 1 illustrates an example arrangement that includes a storage system 100 that has a storage controller 102 coupled to persistent storage 104, where the persistent storage can be implemented with an array of storage devices such as magnetic disk drives or other types of storage devices. The storage system 100 is connected to a network 106, such as a storage area network or other type of network. Hosts 108 are able to access the storage system 100 over the network 106. The hosts 108 can be computers such as desktop computers, portable computers, personal digital assistants (PDAs), and so forth.

The storage controller 102 includes a processor 118, cache control logic 121, and a cache 120. The cache 120 is used to cache data stored in the persistent storage 104, such that subsequent reads can be satisfied from the cache 120 for improved performance. The cache 120 is implemented with storage device(s) that has (have) higher access speeds than the storage devices used to implement persistent storage 104. For example, the cache 120 can be implemented with semiconductor memories, such as dynamic random access memories (DRAMs), static random access memories (SRAMs), flash memories, and so forth. The cache control logic 121 manages the cache 120 according to one or more cache management algorithms. The storage controller 102 is connected to a network interface 122 to allow the storage controller 102 to communicate over the network 106 with hosts 108 and with an administrative station 110.

Although the cache control logic 121 and cache 120 are depicted as being part of the storage controller 102 in FIG. 1, note that in different implementations the cache control logic 121 and cache 120 can be separate from the storage controller 102. More generally, the cache control logic 121 and cache 120 are said to be associated with the storage controller 102.

A snapshot subsystem 105 can be provided in the persistent storage 104. The snapshot subsystem 105 is used for storing snapshots corresponding to different generations of data. A “snapshot” refers to a point-in-time representation of data in the storage system 100. Different generations of snapshots refer to snapshots taken at different points in time. In case of failure, one or more generations of snapshots can be retrieved to recover lost data.

In accordance with some embodiments, “sticky” indicators can be associated with certain data items stored in the cache 120. In some embodiments, the data items associated with sticky indicators are data items associated with certain segments of the snapshot subsystem 105, such as one or more snapshot primary volumes. In certain scenarios, data items may have to be replaced (sacrificed) if the cache 120 needs additional storage space to store other data (e.g., write data associated with write requests). A sticky indicator associated with a data item in the cache is an indicator that prevents displacement of the data item in the cache according to some predefined criteria. In some embodiments, a sticky indicator can be a counter (referred to as a “reclamation escape counter”) associated with a particular data item stored in the cache. The counter can be adjusted (incremented or decremented) as the particular data item moves through a queue associated with the cache. The particular data item is not allowed to be replaced (sacrificed) until the counter has reached a predetermined value (e.g., zero or some other value).

The snapshot subsystem 105 includes a snapshot primary volume A and an associated snapshot pool A, where the snapshot pool A includes one or more volumes. The volumes in the snapshot pool A are used to store prior versions of data that have previously been modified. A “volume” refers to a logical collection of data. Unmodified data, from the perspective of each snapshot, is maintained in the snapshot primary volume A. Multiple generations of snapshots can be maintained, with each snapshot generation made up of data that is based on a combination of unmodified data from the snapshot primary volume A and previously modified data from one or more volumes in the snapshot pool A. The persistent storage can have multiple snapshot primary volumes, with another snapshot primary volume B and associated snapshot pool B illustrated in the example of FIG. 1.

As further depicted in FIG. 1, the persistent storage 104 can also include non-snapshot volumes. In most implementations, non-snapshot volumes make up a large percentage of the volumes that are part of the persistent storage 104. In other words, the snapshot volumes typically make up a small fraction of the persistent storage of the storage system 100. Note that the snapshot subsystem 105 is a more expensive part of the storage system 100, which can be used to store more important data or to store data for users who have subscribed or paid for a higher level of failure protection.

The storage system 100 is also accessible by an administrative station 110, which can also be implemented with a computer. The administrative station 110 is used to control various settings associated with the storage system 100. In accordance with some embodiments, settings that can be adjusted by the administrative station 110 include settings related to which data items of the cache 120 are to be associated with sticky indicators.

In some embodiments, the user at the administrative station 110 can indicate that cached data items for one or more of the snapshot primary volumes in the snapshot subsystem 105 are to be associated with sticky indicators. The setting can be a global setting that indicates that cached data items for all snapshot primary volumes are to be associated with sticky indicators. Alternatively, a user can selectively set a single one or some subset of the snapshot primary volumes are to be associated with sticky indicators.

As depicted in the example of FIG. 1, a graphical user interface (GUI) 112 is presented in a display device of the administrative station 110, where the GUI 112 includes control element 114. The control element 114 is a sticky indicator control element to control which of the snapshot primary volumes are to be associated with sticky indicators in the cache 120. As examples, the sticky indicator control element can include menu control items, icons, and so forth.

FIG. 1 also shows that the administrative station 110 includes control software 124 coupled to the GUI 112, where the control software 124 is executable on a processor 126 that is coupled to memory 128. As noted above, the GUI 112 can be used by a user to control the sticky indicator feature of a cache management algorithm used by the storage controller 102. The control software 124 is responsive to user selections made with the sticky indicator control element 114 to provide commands or messages to the storage controller 102 to indicate which segments of the data storage in the persistent storage 104 are to be associated with sticky indicators.

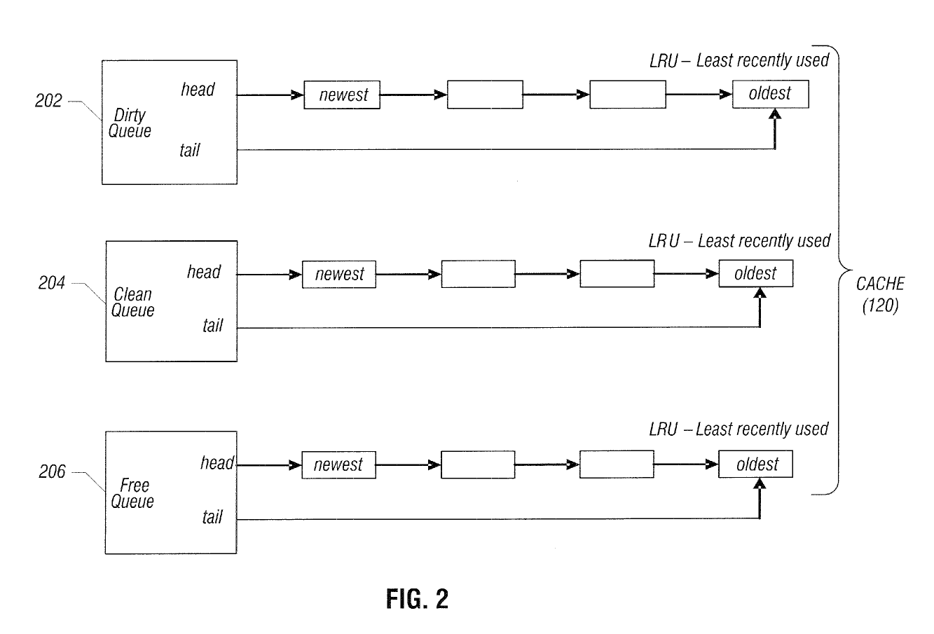

FIG. 2 illustrates example queues (or linked lists) that are logical entities within the cache 120. The queues include a dirty queue 202, a clean queue 204, and a free queue 206. The dirty queue 202 contains host write data that has not yet been written back (destaged) to the persistent storage 104. In some example implementations, write cache data is duplexed (in other words, the host write data is provided in two separate locations of the cache 120). Note that read cache data is not duplexed in some example implementations.

The host write data remains in the dirty queue 202 until the write data is destaged to the persistent storage 104. After destaging, the duplexed write data are moved to the clean queue 204 and free queue 206, with one copy of the write data re-linked onto the clean queue 204, and the other copy of the write data re-linked onto the free queue 206. Read requests can be satisfied from the clean queue 204 (a cache hit for a read request). The clean queue 204 is also referred to as a read queue. Any data in the free queue 206 can be overwritten.

As depicted in the example of FIG. 2, each of the queues 202, 204, and 206 has a head entry and a tail entry, where the head entry of the queue contains the newest data, and the tail entry contains the oldest or least recently used (LRU) data. As noted above, the entries of the free queue 206 are available to be overwritten by new host writes, such that the entry in the free queue 206 containing new host write data is re-linked back to the head of the dirty queue 202. Re-linking an entry of the free queue 206 back to the dirty queue 202 means that such entry becomes logically part of the dirty queue 202.

When no available space exists in the free queue 206, then the LRU entry of the clean queue 204 can be sacrificed to the free queue 206 to be overwritten (replaced) with new host write data. Such a replacement algorithm is an LRU replacement algorithm. In another implementation, another type of replacement algorithm can be used. Sacrificing an entry of the clean queue 204 to the free queue 206 means that such entry of the clean queue 204 is logically linked to the free queue 206.

The queues illustrated in FIG. 2 are provided for purposes of illustration. In different implementations, different arrangements of the cache 120 can be used.

Note that in each of the queues 202, 204, and 206, the head entry is identified by a head pointer, where the head entry contains the newest data item (the most recently accessed data item), while the tail entry is identified by a tail pointer, where the tail entry contains the oldest data item (the least recently accessed data item). As depicted in FIG. 2, four data items are arbitrarily associated with each of the queues. (Note that different numbers of data items can be associated with the queues in other implementations.)

Using a conventional LRU replacement algorithm, if no available space exists in the free queue 206, the entry in the clean queue 204 containing the LRU data item is sacrificed for storing new write data. Sacrificing entries (and associated data items) from the clean queue 204 means that there is a reduced opportunity for a cache hit for subsequent read requests that would otherwise have been satisfied by the data items in the sacrificed entries.

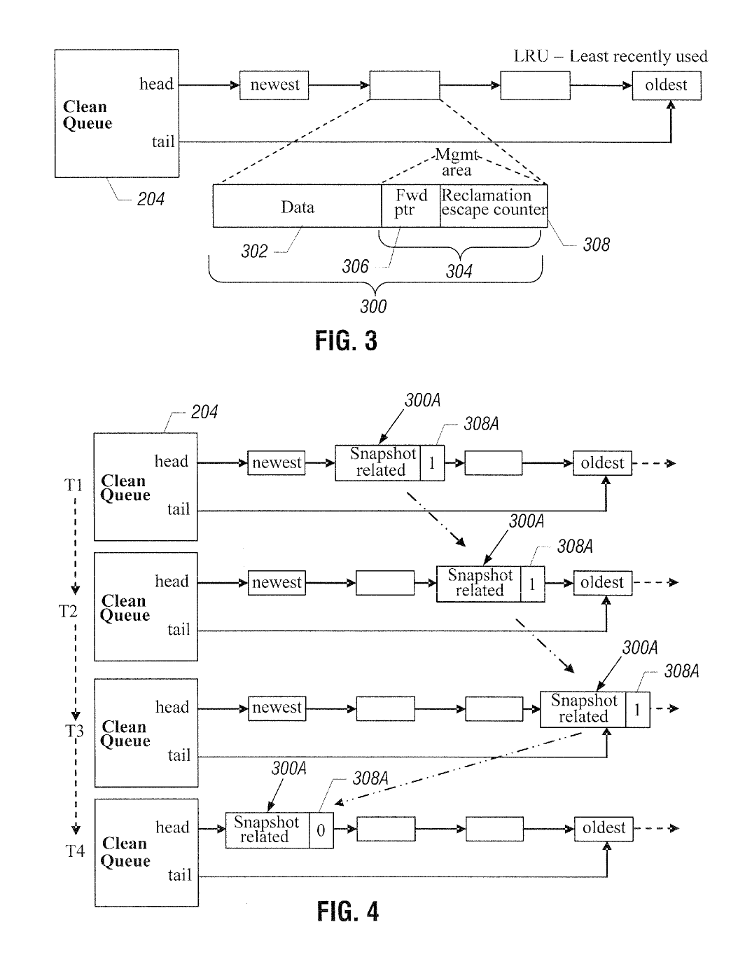

As depicted in FIG. 3, according to some embodiments, to enable certain data items of the clean queue 204 to remain in the clean queue (and thus in the cache 120) for a longer period of time, a sticky indicator is associated with some or all data items. In some embodiments, sticky indicators are associated with cached data items for snapshot primary volumes. Note that in such embodiments sticky indicators would not be associated with cached data items for non-snapshot volumes, or would be simply noted as a reserved (likely all zeros) area in the data structure. Associating sticky indicators with snapshot-related data items (and more specifically, primary snapshot volume-related data items) in the cache allows for snapshot-related data items to be retained in the cache for a longer period of time than non-snapshot-related data items. Increasing cache read hits for snapshot-related data items may lead to enhanced storage system performance, since snapshot primary volumes may be accessed frequently.

For example, there may be multiple requests for data items associated with a snapshot primary volume (requests for normal data as well as requests for snapshot data) pending at various times. Moreover, a host write to a snapshot primary volume may involve a read of a snapshot primary volume (in addition to a write to a snapshot pool volume and a write to the snapshot primary volume). In the above scenarios, retaining snapshot-related data items in the cache 120 for a longer period of time would tend to significantly enhance the storage system performance since it increases cache hits for read requests.

Use of the sticky indicators provides for a modified LRU algorithm, which takes into account values of the sticky indicators when deciding whether or not a data item that has reached a sacrifice point of the clean queue should be sacrificed.

FIG. 3 shows an example data item 300 that is stored in the clean queue 204. Multiple data items 300 are stored in the clean queue 204, which has a head pointer pointing to a most recently de-staged data item, and a tail pointer that points to a least recently de-staged data item. The data item 300 has a data field 302 for storing the actual data, and a management area 304 for storing management-related information. In the example of FIG. 3, the management area 304 includes a forward pointer field 306 to store a forward pointer to point to the next data item. The management area 304 also includes a sticky indicator field 308 for storing the sticky indicator associated with the data item. Note that in data items for which sticky indicators are not to be associated, the management area 304 would not include a valid sticky indicator field 308. Rather, an unused (or reserved) field would likely be provided in place of the sticky indicator field 308.

In other implementations, note that the management area 304 can also include a backwards pointer field to store a backwards pointer to point to a previous data item.

A data item in the clean queue 204 moves from its head to its tail as read requests are received and processed. A cache hit in the clean queue 204 will result in the corresponding data item (that provided the cache hit) to be moved to the head of the clean queue 204. When a data item moves to the tail of the clean queue 204 (or some other predefined sacrifice point of the clean queue 204), the clean queue entry containing the data item becomes a candidate for sacrificing to the free queue 206. However, if a data item is associated with a sticky indicator 308, then the clean queue entry containing the data item is riot sacrificed even though the data item has reached the sacrifice point (.e.g., tail) of the clean queue 204, unless the sticky indicator has reached a predefined value. In the case where the sticky indicator 308 is a reclamation escape counter, that means that the data item associated with the sticky indicator is not sacrificed unless the counter has decremented to zero, for example (or otherwise counted to some other predefined value). Each time such a data item reaches the sacrifice point of the clean queue 204, the counter is decremented (or otherwise adjusted). For example, a reclamation escape counter having a starting value of X would allow the data item to make X more trips through the queue before the clean queue entry containing the data item is a candidate for sacrificing. As a result, this data item would be approximately X times more likely to provide a read cache hit.

FIG. 4 shows data items in the clean queue at four different time points: T1, T2, T3, T4. Of the four data items illustrated, data item 300A is the data item that is associated with a sticky indicator 308A, in this case, a counter having a starting value of 1. As a data item reaches the end of the clean queue 304 (pointed to by the tail pointer—this data item becomes the “oldest”), the clean queue entry containing the data item is a candidate to be sacrificed to populate the free queue 206. At time T2, note that the data item 300A has moved closer to the end of the clean queue 204. At time T3, the data item 300A has reached the end of the clean queue 204. However, since the counter 308A has a non-zero value, the clean queue entry containing the data item 300A is not sacrificed to the free queue. Instead, the counter 308A is decremented to 0, as depicted in time T4, and the data item 300A is moved to the head of the clean queue 204 (just as if the data item 300A has experienced a cache hit). However, note that the next time that the data item 300A reaches the tail of the clean queue 204, the clean queue entry containing this data item 300A will be sacrificed to the free queue. In other words, with the reclamation escape counter 308A reaching 0, the data item is no longer eligible to escape being sacrificed to the free queue.

In the foregoing discussion, reference has been made to a data item “moving” through a queue. According to some implementations, instead of actually moving data items through the queue, it is the head pointer and tail pointer that are updated (1) based on accesses of the queue, and (2) for the clean queue 204, also based on whether the sticky indicator field 308 has reached a predetermined value. Thus, moving a data item in a queue can refer to either physically moving the data item in the queue, or logically moving the data item in the queue by updating pointers or by some other mechanism.

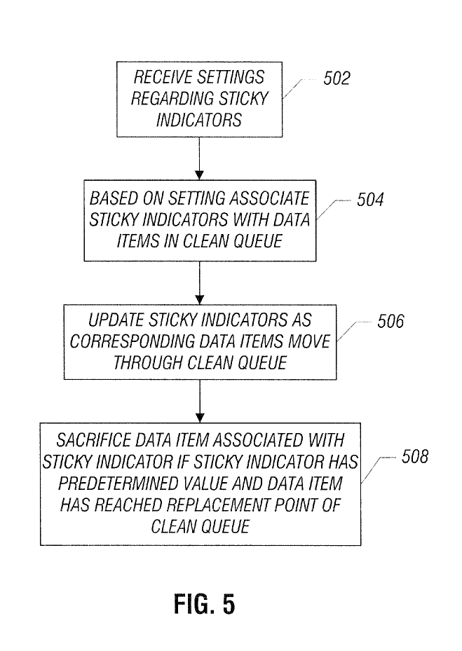

FIG. 5 illustrates a process performed by the storage controller 102 (FIG. 1) according to some embodiments. Note that the tasks of FIG. 5 can be performed by software executable on a storage controller 102, or alternatively, the tasks can be performed by the hardware of the storage controller 102. The storage controller 102 receives (at 502) settings (which can be set by a user, for example) regarding sticky indicators, such as settings from the administrative station 110 (FIG. 1). The settings can indicate that one snapshot primary volume is to be associated with sticky indicators, or alternatively, multiple snapshot primary volumes are to be associated with sticky indicators. Such settings can be stored by the storage controller 102, such as in memory associated with a storage controller 102 or in the persistent storage 104.

Based on the settings, the storage controller 102 is able to associate (at 504) sticky indicators with certain data items in the cache. Thus, if the settings indicate that data items of a particular snapshot primary volume are to be associated with sticky indicators, then if a data item associated with the particular snapshot primary volume is retrieved into the clean queue 204 of the cache 120, the storage controller 102 will associate a sticky indicator for the data item of the particular snapshot primary volume retrieved into the clean queue.

The storage controller 102 updates (at 506) the sticky indicators as the corresponding data items move through the clean queue 204. More specifically, as a data item associated with a sticky indicator moves to a sacrifice point (e.g., tail) of the clean queue 204, the sticky indicator is updated (e.g., a reclamation escape counter is decremented).

The storage controller sacrifices (at 508) a particular data item that is associated with a sticky indicator if the sticky indicator has a predefined value (e.g., reclamation escape counter has decremented to 0) and the data item has reached the sacrifice point of the clean queue. A particular data item being sacrificed refers to an entry of the clean queue being sacrificed to the free queue.

However, a data item associated with a sticky indicator is not sacrificed if the sticky indicator has not reached the predetermined value even though the data item has reached the sacrifice point.

Instructions of software described above (including software of the storage controller 102, for example) are loaded for execution on a processor. The processor includes microprocessors, microcontrollers, processor modules or subsystems (including one or more microprocessors or microcontrollers), or other control or computing devices. As used here, a “processor” can refer to a single component or to plural components.

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method executed by at least one processor in a storage system, comprising:
storing data items in a cache of the storage system, wherein the data items are for a snapshot volume;
associating sticky indicators with the data items in the cache, the sticky indicators to delay removal of corresponding data items from the cache; and
sacrificing data items of the cache according to a replacement algorithm that takes into account the sticky indicators associated with the data items.

2. The method of claim 1, wherein each of the sticky indicators comprises a counter, the method further comprising:
decrementing the counter of a particular one of the data items in response to the particular data items moving to a sacrifice point in the cache.

3. The method of claim 2, further comprising:
allowing the particular data item to be sacrificed in response to the counter of the particular data item reaching a predetermined value and the particular data item having moved to the sacrifice point in the cache.

4. The method of claim 3, further comprising:
preventing the particular data item from being sacrificed in response to the counter of the particular data item not being at the predetermined value, even though the particular data item has moved to the sacrifice point in the cache.

5. The method of claim 4, where the cache comprises a read queue and a second queue, and wherein sacrificing the particular data item comprises sacrificing an entry of the read queue to the second queue.

6. The method of claim 2, where the replacement algorithm comprises a least recently used replacement algorithm.

7. The method of claim 1, wherein storing the data items in the cache comprises storing the data items in a read queue of the cache, wherein the cache further comprises a dirty queue to store write data that has not been destaged to persistent storage, and a free queue to be overwritten with write data of subsequent write requests.

8. The method of claim 7, wherein sacrificing the data items comprises sacrificing the entries of the read queue containing the data items from the read queue to the free queue.

9. The method of claim 7, further comprising:
receiving a read request; and
satisfying the read request from the read queue if data for the read request is found in the read queue.

10. The method of claim 1, further comprising:
storing non-snapshot related data items in the cache, wherein sticky indicators are not associated with the non-snapshot related data items in the cache; and
sacrificing the non-snapshot related data items from the cache using the replacement algorithm without considering sticky indicators.

11. The method of claim 1, wherein the snapshot volume comprises a primary snapshot volume, the method further comprising:
storing a snapshot pool of volumes to store prior generations of modified data.

12. The method of claim 1, further comprising:
receiving settings set in a user interface regarding which data items are to be associated with sticky indicators and which data items are not to be associated with data items.

13. A storage system comprising:
a persistent storage that includes a snapshot volume and a non-snapshot volume;
a cache; and
a storage controller associated with the cache, the storage controller to:
associate sticky indicators with data items of the snapshot volume in the cache, wherein the sticky indicators are used to cause retention of the data items in the cache,
sacrifice data items of the cache using a replacement algorithm that takes into account the sticky indicators.

14. The storage system of claim 13, wherein the storage controller is configured to further:
update a sticky indicator of a particular data item as the particular data item moves in the cache;
prevent the particular data item from being sacrificed in response to the sticky indicator of the particular data item not being at a predetermined value, even though the particular data item has moved to a sacrifice point in the cache.

15. The storage system of claim 14, wherein the storage controller is configured to further:
allow the particular data item to be sacrificed in response to the sticky indicator of the particular data item reaching a predetermined value and the particular data item having moved to the sacrifice point in the cache.

16. The storage system of claim 15, wherein the sacrifice point is a tail of a queue in the cache.

17. The storage system of claim 13, wherein each of the sticky indicators comprises a counter, the controller configured to further:
decrement the counter of a particular one of the data items in response to the particular data items moving to a sacrifice point in the cache.

18. An article comprising at least one computer-readable storage medium containing instructions that when executed cause a storage system to:
store data items in a cache of the storage system, wherein the data items are for a snapshot volume;
associate sticky indicators with the data items in the cache, the sticky indicators to delay removal of corresponding data items from the cache; and
sacrifice data items of the cache according to a replacement algorithm that takes into account the sticky indicators associated with the data items.

19. The article of claim 18, wherein each of the sticky indicators comprises a counter, the instructions when executed causing the storage system to further:
decrement the counter of a particular one of the data items in response to the particular data items moving to a sacrifice point in the cache.

20. The article of claim 18, wherein the data items are stored in a read queue, and wherein the instructions when executed cause the storage system to further:
receive a read request; and
provide read data from the read queue in response to the read request.
